(19) United States
(12) Patent Application Publication
(10) Pub. No.: US 2009/0113923 A1
(43) Pub. Date: May 7, 2009

(54) REFRIGERATOR AND CONTROL METHOD FOR THE SAME

(76) Inventor: Song Gye Young, Seoul (KR)

Correspondence Address: KED & ASSOCIATES, LLP, P.O. Box 221200, Chantilly, VA, 20153-1200, US

(21) Appl. No.: 12/244,867

(22) Filed: Oct. 3, 2008

(30) Foreign Application Priority Data
Nov. 5, 2007 (KR) 10-2007-0112270

(51) Int. Cl. F25D 11/02; F25D 17/06; G05D 7/00; G05D 23/00; F25B 29/00

(52) U.S. Cl. 62/441; 62/408; 700/282; 700/299; 62/159

(57) ABSTRACT

A refrigerator and a control method for the same are disclosed. The refrigerator includes a convertible storage room capable of performing a refrigerating function and a freezing function selectively or simultaneously, so as to allow a user to conveniently store a variety of food. More particularly, the refrigerator includes a body including a refrigerating storage room and a freezing storage room, a convertible storage room located between the refrigerating storage room and the freezing storage room, to selectively perform one of a freezing function and a refrigerating function, a first evaporator that cools the refrigerating storage room and a second evaporator that cools the freezing storage room and the convertible storage room selectively or simultaneously, and a cold air supply device that selectively supplies the cold air generated from the second evaporator into the freezing storage room and the convertible storage room.

This application claims priority to Korean Patent Application No.: 10-2007-0112270, filed in Korea on Nov. 5, 2007, which is hereby incorporated by reference in its entirety.

### BACKGROUND

1. Field

A refrigerator and a control method for the same are disclosed herein.

2. Background

Refrigerators are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 is a diagram of a refrigerator according to an embodiment;

FIG. 2 is a front perspective view of a refrigerator according to another embodiment;

FIG. 3 is a side sectional view of the refrigerator of FIG. 2; and

FIG. 4 is a schematic diagram illustrating a refrigeration cycle of the refrigerator of FIG. 2.

### DETAILED DESCRIPTION

Reference will now be made in detail to embodiments, examples of which are illustrated in the accompanying drawings.

Generally, a refrigerator is an appliance designed to store food at a low temperature. According to the condition of the food to be stored, the food may be kept in a chilled or frozen state in a refrigerating storage room or freezing storage room of the refrigerator.

The refrigerator incorporates a refrigeration cycle including compression, condensation, expansion, and evaporation of a refrigerant. A low-temperature refrigerant is obtained by repeatedly performing the refrigeration cycle, and the refrigerant is supplied into an interior of the refrigerator. As the supplied refrigerant is delivered uniformly, by convection, throughout the interior of the refrigerator, it functions to maintain food in a fresh state.

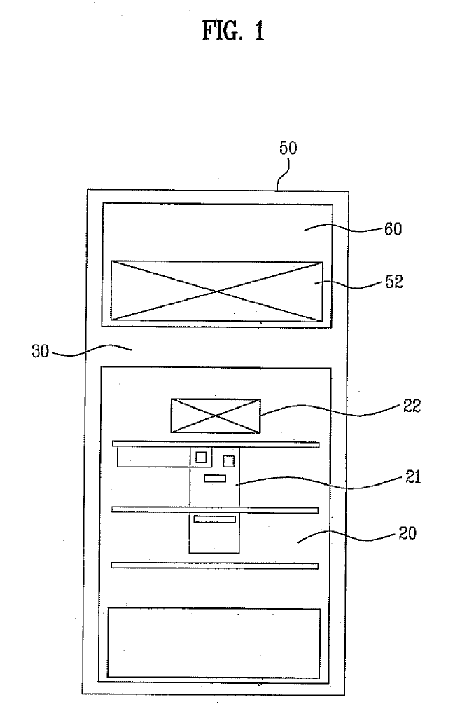

FIG. 1 is a diagram of a refrigerator according to an embodiment. As shown in FIG. 1, the refrigerator includes a body 50 defining a freezing compartment or storage room 60 in an upper region thereof and a refrigerating compartment or storage room 20 in a lower region thereof. The freezing storage room 60 and the refrigerating storage room 20 may be separated from each other by a first partition 30.

The freezing storage room 60 may be provided with a freezing storage room evaporator 52 that generates and supplies cold air into the freezing storage room 60. The refrigerating storage room 20 may be provided with a refrigerating storage room evaporator 22. A duct 21 may be coupled to a rear surface of the refrigerating storage room 20, which is configured to receive cold air generated by the refrigerating storage room evaporator 22. Cold air may be introduced into the refrigerating storage room 20 through the duct 21, to circulate in the refrigerating storage room 20.

As the cold air circulates in the freezing storage room 60 and the refrigerating storage room 20, the interior of the freezing compartment 60 and the interior of the refrigerating compartment 20 are kept at low temperatures. As a result, food stored in the freezing and refrigerating storage rooms 10 and 60 may be kept fresh.

However, the above described refrigerator has at least the following disadvantages. First, in the refrigerator of FIG. 1, the temperature of the refrigerating storage room 20 and the temperature of the freezing storage room 60 belong to predetermined temperature zones, respectively. Therefore, when various kinds of food including chilled food, frozen food, or similar items are stored in the refrigerator, the refrigerator cannot effectively store the food. Second, the refrigerator of FIG. 1 defines only a predetermined temperature zone, and cannot widely change the temperature zone. Therefore, it has the problems of excessive consumption of electricity and deteriorated refrigeration efficiency.

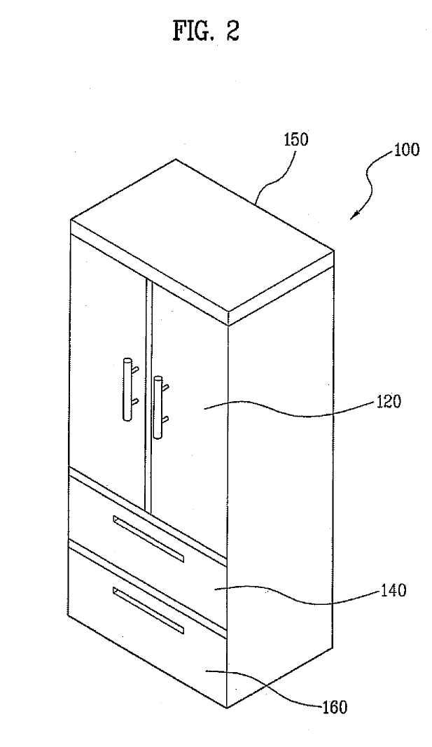

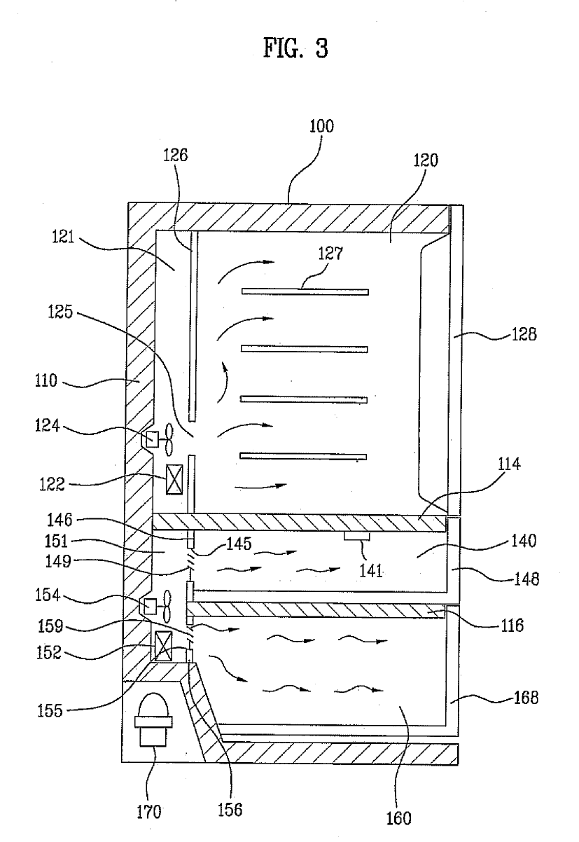

FIG. 2 is a front perspective view of a refrigerator according to another embodiment. FIG. 3 is a side sectional view of the refrigerator of FIG. 2.

As shown in FIG. 2, the refrigerator 100 according to this embodiment may include a body 150 defining therein a refrigerating storage room 120 and a freezing storage room 160 located below the refrigerating storage room 120. The refrigerator 100 may further include a switching compartment or convertible storage room 140 located between the refrigerating storage room 120 and the freezing storage room 160 that selectively performs one of a freezing function and a refrigerating function.

The body 100 may includes a first partition 114 that separates the refrigerating storage room 120 and the convertible storage room 140 from each other, and a second partition 116 that separates the convertible storage room 140 and the freezing storage room 160 from each other. The first partition 114 may prevent transfer of heat between the refrigerating storage room 120 and the convertible storage room 140, and the second partition 116 may prevent transfer of heat between the convertible storage room 140 and the freezing storage room 160.

The body 100 may further include, in a rear lower region thereof, a compressor 170 that compresses a refrigerant and a condenser 180 that condenses the compressed refrigerant. The refrigerant, having passed through the compressor 170 and the condenser 180, may be supplied to a first evaporator 122 and a second evaporator 152.

The refrigerating storage room 120 may be located in an upper region of the body 100, and refrigerating storage room doors 128 may be provided at a front surface of the refrigerating storage room 120, to open or close the refrigerating storage room 120. The refrigerating storage room 120 may also include shelves 127 arranged vertically in multiple stages to sort and support food thereon. Although FIG. 2 illustrates a two French door-type refrigerating storage room doors 128 that may be opened leftward and rightward, respectively, these doors may be replaced, for example, by a single door coupled to the body 100 by means of, for example, a hinge.

The first evaporator 122 may be installed at a rear side of the refrigerating storage room 120, to generate and supply cold air into the refrigerating storage room 120, so as to allow the cold air to be heat-exchanged with the existing-air in the refrigerating storage room 120. In addition to the first evaporator 122, a first blowing fan 124 may be installed at the rear side of the refrigerating storage room 120, to generate a blowing force required to forcibly circulate the cold air generated by the first evaporator 122 into the refrigerating storage room 120.

To supply the cold air generated by the first evaporator 122 into the refrigerating storage room 120, a first duct 121 may be defined between a rear wall 110 of the body 100 and a rear wall 126 of the refrigerating storage room 120. The first duct 121 may provide a cold air flow path for the first evaporator 122. The rear wall 126 of the refrigerating storage room 120 may be provided with a plurality of discharge holes 125, to discharge the cold air from the first duct 121 into the refrigerating storage room 120.

The freezing storage room 160 may be located in a lower region of the body 100. The freezing storage room 160 may be provided, at a front surface thereof, with a freezing storage room door 168, to open or close the freezing storage room 160. The freezing storage room door 168 may be, for example, a drawer type door that may be pulled out of or pushed into the body 100. To allow the freezing storage room door 168 to be slidably pulled out of or pushed into the body 100, the body 100 may be provided, at opposite inner side surfaces thereof, with guiding members (not shown), and the freezing storage room door 168 may be provided, at opposite outer side surfaces thereof, with guide rails (not shown) corresponding to the respective guide members.

To supply the cold air generated from the second evaporator 152 into the freezing storage room 160 and the convertible storage room 140, a second duct 151 may be defined between the rear wall 110 of the body 110, a rear wall 156 of the freezing storage room 160, and a rear wall 146 of the convertible storage room 140. The second duct 151 may provide a cold air flow path for the second evaporator 152.

The rear wall 156 of the freezing storage room 160 may be provided with a plurality of discharge holes 155, to discharge the cold air from the second duct 151 into the freezing storage room 160. The rear wall 146 of the convertible storage room 140 may be provided with a plurality of discharge holes 145, to discharge the cold air from the second duct 151 into the convertible storage room 140.

The convertible storage room 140 may be located between the refrigerating storage room 120 and the freezing storage room 160, and may be adapted to perform both a refrigerating function and a freezing function. The convertible storage room 140 may be provided, at a front surface thereof, with a convertible storage room door 148, to open or close the convertible storage room 140. The convertible storage room door 148 may be, for example, a drawer type door to be pulled out of or pushed into the body 100.

Similar to the freezing storage room door 168, the body 100 may be provided, at opposite inner side surfaces thereof, with guiding members (not shown). The convertible storage room door 148 may be provided, at opposite outer side surfaces thereof, with guide rails (not shown) corresponding to the respective guide members.

The convertible storage room 140, located between the refrigerating storage room 120 and the freezing storage room 160, may be positioned at a height suitable to allow a user to conveniently put or take food into or out of the convertible storage room 140. The second evaporator 152 may be installed in a space defined by the rear wall 110 of the body 100, the rear wall 156 of the freezing storage room 160, and the rear wall 145 of the convertible storage room 140. The cold air generated from the second evaporator 152 may be supplied into the freezing storage room 160 or the convertible storage room 140, so as to be heat exchanged with the existing air in the freezing storage room 160 or the convertible storage room 140.

In embodiments disclosed herein, instead of providing the convertible storage room 140 and the freezing storage room 160 with evaporators, respectively, only a single second evaporator 152 may be allotted to the freezing storage room 160 and the convertible storage room 140. This reduces an overall size of the refrigerator, and simplifies an installation structure for the evaporator. It should be appreciated that an installation position of the second evaporator 152 may be changed according to the arrangement of the freezing storage room 160 and the convertible storage room 140.

Meanwhile, the refrigerator of FIG. 2 may further include a cold air supply device, that selectively supplies the cold air generated by the second evaporator 152 into the freezing storage room 160 and the convertible storage room 140. The cold air supply device may include a second blowing fan 154 that moves the cold air generated by the second evaporator 152 into the freezing storage room 160 and the convertible storage room 140, a damper that controls an amount of cold air to be introduced into the convertible storage room 140 or the freezing storage room 160, and a temperature sensor 141 that detects an interior temperature of the convertible storage room 140.

The damper may include a first damper 149 and a second damper 159. The first damper 149 may be installed in the discharge hole 145 of the convertible storage room 140, for example, in a cold air inlet port through which the cold air generated in the second duct 151 may be introduced into the convertible storage room 140. The first damper 149 may serve to adjust the amount of cold air to be introduced into the convertible storage room 140. The second damper 159 may be installed in the discharge hole 155 of the freezing storage room 160, for example, in a cold air inlet port through which the cold air generated in the second duct 151 may be introduced into the freezing storage room 160. The second damper 159 may serve to adjust the amount of cold air to be introduced into the freezing storage room 160.

The second blowing fan 154 may generate a blowing force to forcibly circulate the cold air, generated from the second evaporator 152, into the freezing storage room 160 and/or the convertible storage room 140. The temperature sensor 141 may be attached to an inner surface of the convertible storage room 140, to detect a variation in the interior temperature of the convertible storage room 140. On the basis of temperature data detected by the temperature sensor 141, an operation of the second blowing fan 154 and the first damper 149 may be controlled.

Although not shown in the drawings, it should be appreciated that the freezing storage room 160 may be provided with a temperature sensor, to control operation of the second blowing fan 154 and the second damper 159.

The cold air supply device may be controlled to keep the interior temperature of the convertible storage room 140 having the above described configuration in a temperature zone of ^{˜}−18° C. to ^{˜}8° C. Thus, the convertible storage room 140 may be used to store chilled food or frozen food selectively.

Although a height of the convertible storage room 140 may be selected by a user according to a kind of food to be stored in the convertible storage room 140, in this embodiment, the convertible storage room 140 may have a height of more than ^{˜}200 mm.

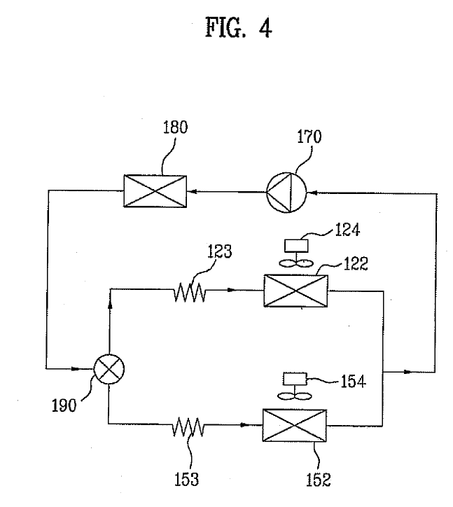

Hereinafter, operation of a refrigerator according to an embodiment will be described with reference to FIGS. 3 and 4.

In a refrigerating operation for the refrigerating storage room 120, a high-temperature and high-pressure gas-phase refrigerant generated by the compressor 170 may be delivered into the condenser 180, and the condenser 180 may condense the high-temperature and high-pressure refrigerant into a medium-temperature and high-pressure liquid-phase refrigerant. Then, the liquefied refrigerant may be delivered into a first expansion tube 123 by way of a three-way valve 190. The refrigerant may be depressurized while passing through the first expansion tube 123, thereby changing it into a low-temperature and low-pressure refrigerant. Thereafter, the refrigerant may be introduced into the first evaporator 122, and finally, the refrigerant, having passed through the first evaporator 122, may be returned to the compressor 170.

The refrigerant introduced into the first evaporator 122 may be used to generate cold air, and the first blowing fan 124 operated. With the operation of the first blowing fan 124, the cold air generated from the first evaporator 122 may be circulated into the refrigerating storage room 120 through the discharge holes 125 provided in the rear wall 126 of the refrigerating storage room 120, to perform the refrigerating operation for the refrigerating storage room 120.

The compressor 170 and the first blowing fan 124 may operate until the interior temperature of the refrigerating storage room 120 is lowered below a preset temperature. That is, when the interior temperature of the refrigerating storage room 120 is lowered below the preset temperature, the operation of the compressor 170 and the first blowing fan 124 may be stopped.

Next, in a selective operation for the freezing storage room 160 and the convertible storage room 140, a high-temperature and high-pressure gas-phase refrigerant generated from the compressor 170 may be delivered into the condenser 180, and the condenser 180 may condense the high-temperature and high-pressure refrigerant into a medium-temperature and high-pressure liquid-phase refrigerant. Then, the liquefied refrigerant may be delivered into a second expansion tube 153 by way of the three-way valve 190. The refrigerant may be depressurized while passing through the second expansion tube 153, thereby changing it into a low-temperature and low-pressure refrigerant. Thereafter, the refrigerant may be introduced into the second evaporator 152, and finally, the refrigerant, having passed through the second evaporator 152, may be returned to the compressor 170.

The refrigerant introduced into the second evaporator 152 generates cold air, and the second blowing fan 154 may be operated. With the operation of the second blowing fan 154, the cold air generated by the second evaporator 152 may be circulated into the freezing storage room 160 through the discharge holes 155 provided in the rear wall 156 of the freezing storage room 160, to perform a freezing operation for the freezing storage room 160.

Meanwhile, with the operation of the second blowing fan 154, a portion of the cold air generated by the second evaporator 152 may be guided along the second duct 151, so as to be circulated into the convertible storage room 140 through the discharge holes 154 provided in the rear wall 146 of the convertible storage room 140. Thereby, the cold air may be used to lower the interior temperature of the convertible storage room 140.

If it is detected, by the temperature sensor 141 of the cold air supply device, that the interior temperature of the convertible storage room 140 is lower than a user's desired temperature, the operation of the second blowing fan 154 may be stopped or the first damper 149 closed under the control of a controller (not shown), to raise the interior temperature of the convertible storage room 140. Also, if the interior temperature of the convertible storage room 140 is higher than the user's desired temperature, the second blowing fan 154 may be further operated or the first damper 149 opened, to lower the interior temperature of the convertible storage room 140.

In conclusion, the interior temperature of the convertible storage room 140 may be kept at the user's desired temperature as the above described operation is repeatedly performed, and the convertible storage room 140 may store food, which must be kept in a specific temperature zone, in a fresh state for an extended period of time. As described above, according to embodiments disclosed herein, the amount of cold air supplied into the convertible storage room 140 may be controlled by the first damper 149, the second damper 159, the second blowing fan 154, and the temperature sensor 141, to keep the convertible storage room 140 and the freezing storage room 160 at appropriate temperatures in accordance with the user's selection.

Now, a control method for the refrigerator according an embodiment will be described. Although not shown in the drawings, the refrigerator according to embodiments disclosed herein may include a controller electrically connected with the compressor 170, the condenser 180, and the cold air supply device, to control these respective devices.

First, the control method for a refrigerator according to this embodiment may include measuring information related to a condition of the convertible storage room 140, and controlling the cold air supply device on the basis of the measured information, to supply the cold air into the convertible storage room 140 and the freezing storage room 160 selectively or simultaneously. The information related to the condition of the convertible storage room 140, for example, the interior temperature of the convertible storage room 140 may be measured by the temperature sensor 141 of the cold air supply device. Then, the measured interior temperature of the convertible storage room 140 may be compared with a preset temperature.

If the interior temperature of the convertible storage room 140 is higher than the preset temperature, the first damper 149 may be closed or the operation of the second blowing fan 154 stopped under the control of the controller, to prevent the cold air from being further introduced into the convertible storage room 140. When the second blowing fan 154 is operated in a state in which the first damper 149 is closed, the cold air generated by the second evaporator 152 may be introduced only into the freezing storage room 160.

On the other hand, if it is determined, based on the result of comparing the interior temperature of the convertible storage room 140 with the preset temperature, that the interior temperature of the convertible storage room 140 is lower than the preset temperature, the first damper 149 and the second damper 159 may be opened or the operation of the second blowing fan 154 resumed under the control of the controller, to introduce the cold air into the convertible storage room 140 and/or the freezing storage room 160. Alternatively, the control method for the refrigerator according to an embodiment may include a first cooling operation for cooling the refrigerating storage room 120, and a second cooling operation for cooling the freezing storage room 160 and the convertible storage room 140 selectively or simultaneously. The first cooling operation and the second cooling operation may be performed selectively or simultaneously.

In this control method, first, the controller may determine the operating mode of the refrigerator selected by the user. In the first cooling operation, the refrigerant, having passed through the compressor 170 and the condenser 180, may be delivered through the first expansion tube 123 and the first evaporator 122 as a result of controlling the refrigerant flow-path converting valve 190, thereby causing a cooling operation for the refrigerating storage room 120. In the second cooling operation, the refrigerant, having passed through the compressor 170 and the condenser 180, may be delivered through the second expansion tube 153 and the second evaporator 152 as a result of controlling the refrigerant flow-path converting valve 190 and the cold air supply device, thereby causing cooling operations for the freezing storage room 160 and the convertible storage room 140 selectively or simultaneously.

Accordingly, by controlling the refrigerant flow-path converting valve 190, the refrigerant may be guided to pass through both the first evaporator 122 and the second evaporator 152, or to pass through only a selected one of the first evaporator 122 and the second evaporator 152. In this manner, the first cooling operation and the second cooling operation may be performed simultaneously or selectively.

Embodiments disclosed herein provide a refrigerator that includes a switching compartment or convertible storage room, provided separately from a refrigerating compartment or storage room and a freezing compartment or storage room capable of performing both refrigerating and freezing functions, and a control method for the same. A refrigerator according to embodiments disclosed herein may change a temperature zone thereof according to a user's selection.

Embodiments disclosed herein provide a refrigerator that includes a body including a refrigerating storage room and a freezing storage room, a convertible storage room located between the refrigerating storage room and the freezing storage room, to selectively perform any one of freezing and refrigerating functions, a first evaporator to cool the refrigerating storage room and a second evaporator to cool the freezing storage room and the convertible storage room selectively or simultaneously, and a cold air supply device to selectively supply cold air generated from the second evaporator into the freezing storage room and the convertible storage room. The cold air supply device may include a blowing fan to introduce the cold air generated from the second evaporator into the freezing storage room and the convertible storage room, a damper to control the amount of cold air to be introduced into the convertible storage room and the freezing storage room, and a temperature sensor to detect the interior temperature of the convertible storage room.

The damper may include a first damper provided at a rear wall of the convertible storage room, to control the amount of cold air to be introduced into the convertible storage room, and a second damper provided at a rear wall of the freezing storage room, to control the amount of cold air to be introduced into the freezing storage room. The first damper may be installed at a cold air inlet port for the convertible storage room. The second evaporator may be installed a space defined between a rear wall of the body, a rear wall of the freezing storage room, and a rear wall of the convertible storage room.

The convertible storage room may be a drawer type configured to be pulled out of or pushed into the body. The convertible storage room may have a temperature zone of ^{˜}−18° C. to ^{˜}8°, to perform both the freezing and refrigerating functions.

Further, embodiments disclosed herein provide a control method for a refrigerator that includes measuring information related to the condition of a convertible storage room, and controlling a cold air supply device based on the measured information, to supply cold air into the convertible storage room and a freezing storage room selectively or simultaneously. The control of the cold air supply device may include controlling a blowing fan and a damper by detecting the interior temperature of the convertible storage room.

Embodiments disclosed herein also provide a control method for a refrigerator that includes performing a first cooling operation to cool a refrigerating storage room, and performing a second cooling operation to cool a free-zing storage room and a convertible storage room selectively or simultaneously. The first cooling operation and the second cooling operation may be performed selectively or simultaneously.

A refrigerator and a control method for the same according to embodiments disclosed herein have at least the following advantages. First, providing a convertible storage room capable of performing both refrigerating and freezing functions, allows chilled food or frozen food to be selectively stored in the convertible storage room. This enhances a convenience in use. Second, using the convertible storage room at various temperature zones has the effect of providing the refrigerator with low consumption of electricity and enhanced operating efficiency.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A refrigerator, comprising:
a body including a refrigerating storage room and a freezing storage room;
a convertible storage room located between the refrigerating storage room and the freezing storage room, wherein the convertible storage room can maintain a plurality of temperatures that range between a temperature for a refrigerating storage room and a temperature for a freezing storage room;
a first evaporator that cools the refrigerating storage room and a second evaporator that cools the freezing storage room and the convertible storage room selectively or simultaneously; and
a cold air supply device that selectively supplies cold air generated by the second evaporator into the freezing storage room and the convertible storage room.

2. The refrigerator according to claim 1, wherein the cold air supply device comprises:
a blowing fan that introduces the cold air generated by the second evaporator into the freezing storage room and the convertible storage room; and
a damper device that controls an amount of cold air introduced into at least one of the convertible storage room and the freezing storage room.

3. The refrigerator according to claim 2, wherein the cold air supply device further comprises:
a temperature sensor that detects an interior temperature of the convertible storage room.

4. The refrigerator of claim 3, further comprising a controller that controls the blowing fan and damper device in response to the detected interior temperature.

5. The refrigerator of claim 4, wherein the controller compares the detected interior temperature to a preset temperature and controls the blowing fan and damper device based on the comparison result.

6. The refrigerator according to claim 2, wherein the damper device comprises:
a first damper that controls the amount of cold air introduced into the convertible storage room; and
a second damper that controls the amount of cold air introduced into the freezing storage room.

7. The refrigerator according to claim 6, wherein the first damper is installed in a cold air inlet duct of the convertible storage room.

8. The refrigerator according to claim 6, wherein the second damper is installed in a cold air inlet duct of the freezing storage room.

9. The refrigerator according to claim 1, wherein the second evaporator is installed between a rear wall of the body, a rear wall of the freezing storage room, and a rear wall of the convertible storage room.

10. The refrigerator according to claim 1, wherein the body comprises guiding members that allow a container to be pulled out of or pushed into the convertible storage room.

11. The refrigerator according to claim 1, wherein the convertible storage room can maintain temperatures ranging between approximately −18° C. and −8° C., to perform both the freezing and refrigerating functions.

12. A control method for a refrigerator, comprising:
measuring information related to a condition of a convertible storage room; and
controlling a single cold air supply device based on the measured information, to supply cold air into the convertible storage room and a freezing storage room selectively or simultaneously.

13. The control method according to claim 12, wherein measuring information related to a condition of the convertible storage room comprises measuring an interior temperature of the convertible storage room and controlling the single cold air supply device comprises controlling a blowing fan and a damper device based on the detected interior temperature.

14. The control method according to claim 12, wherein measuring information related to a condition of the convertible storage room comprises measuring an interior temperature of the convertible storage room and controlling the single cold air supply device comprises controlling a blowing fan and a plurality of dampers based on the detected interior temperature, wherein the plurality of dampers comprise a first damper that controls the amount of cold air introduced into the convertible storage room, and a second damper that controls the amount of cold air introduced into the freezing storage room.

15. The control method of claim 12, wherein measuring information related to a condition of the convertible storage room comprises measuring an interior temperature of the convertible storage room using a temperature sensor disposed within an interior of the convertible storage room.

16. The control method of claim 12, wherein measuring information related to a condition of the convertible storage room comprises measuring an interior temperature of the convertible storage room and comparing the interior temperature to a preset temperature.

17. A control method for a refrigerator, comprising:
performing a first cooling operation to cool a refrigerating storage room; and
performing a second cooling operation to cool a freezing storage room and a convertible storage room selectively or simultaneously, wherein the first cooling operation and the second cooling operation are performed selectively or simultaneously.

18. The control method of claim 18, wherein performing a second cooling operation to cool a freezing storage room and a convertible storage room selectively or simultaneously comprises controlling a blowing fan and a damper to supply cool air to the freezing storage room and convertible storage room selectively or simultaneously.

19. The control method of claim 17, wherein performing a second cooling operation to cool a freezing storage room and a convertible storage room selectively or simultaneously comprises detecting an interior temperature of the convertible storage room and performing the second cooling operation based on the detected temperature.

20. The control method of claim 18, wherein detecting an interior temperature of the convertible storage room comprises comparing the detected temperature to a preset temperature and performing the second cooling operation based on the comparison results.
